(19) United States
(12) Patent Application Publication
(10) Pub. No.: US 2020/0233588 A1
(43) Pub. Date: Jul. 23, 2020

(54) EFFICIENT LIGHTWEIGHT STORAGE NODES

(71) Applicant: Alibaba Group Holding Limited, Grand Cayman (KY)

(72) Inventor: Shu Li, Bothell, WA (US)

(73) Assignee: Alibaba Group Holding Limited, Grand Cayman (KY)

(21) Appl. No.: 16/255,327

(22) Filed: Jan. 23, 2019

(51) Int. Cl. G06F 3/06; G06F 9/30; H04L 9/06

(52) U.S. Cl. CPC G06F 3/0619; G06F 9/30007; G06F 3/0641; G06F 9/3877; G06F 3/0679; H04L 9/0643; G06F 3/0665

(57) ABSTRACT

Embodiments described herein provide an apparatus facilitating a storage node. The apparatus can include a plurality of non-volatile memory devices, an interface, a processing module comprising a plurality of cores, an acceleration module, and a storage module. During operation, the interface receives data for storing in a non-volatile memory device of the plurality of non-volatile memory devices. A core of the processing module then translates the data for storing in the non-volatile memory device and send the data to the non-volatile memory device. The acceleration module then performs a set of specialized operations on the data. Subsequently, the storage module stores the data in the non-volatile memory device.

### BACKGROUND

### Field

This disclosure is generally related to the field of storage management. More specifically, this disclosure is related to a system and apparatus for facilitating an efficient lightweight storage node based on reduced intermediate protocol overhead.

### Related Art

The exponential growth of the Internet has made it a popular delivery medium for a variety of applications running on physical and virtual devices. Such applications have brought with them an increasing demand for computing resources. As a result, equipment vendors race to build larger and faster computing equipment (e.g., processors, storage, memory devices, etc.) with versatile capabilities. However, the capability of a piece of computing equipment cannot grow infinitely. It is limited by physical space, power consumption, and design complexity, to name a few factors. Furthermore, computing devices with higher capability are usually more complex and expensive. More importantly, because an overly large and complex system often does not provide economy of scale, simply increasing the size and capability of a computing device to accommodate higher computing demand may prove economically unviable.

To facilitate a viable solution, a large-scale infrastructure, such as a datacenter, typically disaggregates compute and storage nodes and couples them with a high-throughput fabric. As a result, even though the storage nodes are equipped with processors, they mostly perform the backend storage-related processing, which may result in under-utilization of the processing capabilities of the storage nodes. Since a storage node is used for data storage, that node typically needs a storage technology that can provide large storage capacity as well as efficient storage/retrieval of data. One such storage technology can be based on Not AND (NAND) flash memory devices (or flash devices). NAND flash devices can provide high capacity storage at a low cost. As a result, NAND flash devices have become the primary competitor of traditional hard disk drives (HDDs) as a persistent storage solution.

Even though NAND flash devices have brought many desirable features to storage nodes, many problems remain unsolved in data processing within a storage node.

### SUMMARY

Embodiments described herein provide an apparatus facilitating a storage node. The apparatus can include a plurality of non-volatile memory devices, an interface, a processing module comprising a plurality of cores, an acceleration module, and a storage module. During operation, the interface receives data for storing in a non-volatile memory device of the plurality of non-volatile memory devices. A core of the processing module then translates the data for storing in the non-volatile memory device and send the data to the non-volatile memory device. The acceleration module then performs a set of specialized operations on the data. Subsequently, the storage module stores the data in the non-volatile memory device.

In a variation on this embodiment, the acceleration module includes one or more of: a compression module, a hash module, a compaction module, an encryption module, and a deduplication module. The compression module compresses the data, the hash module computes a hash of the data, and the deduplication module removes redundancy from the data. The encryption module encrypts the data and the compaction module represents the data in a compact representation for storing in the non-volatile memory device.

In a variation on this embodiment, the apparatus also includes a system memory device that stores the data. The core can then obtain the data from the system memory.

In a variation on this embodiment, the plurality of non-volatile memory devices includes multiple sets of non-volatile memory devices. A respective set of non-volatile memory devices is associated with an error-correction module and a memory-interfacing module.

In a further variation, the non-volatile memory device is in the set of non-volatile memory devices. The error-correction module applies an error-correction coding (ECC) to the data, and the memory-interfacing module programs the data in the non-volatile memory device.

In a variation on this embodiment, the storage module can also include a data recovery module that can perform error-correction preprocessing and data storage virtualization.

In a variation on this embodiment, the apparatus also includes a static memory device that operates as a buffer for the processing module and a read-only memory that stores configuration information for the apparatus.

In a variation on this embodiment, the apparatus cools based on an external fan.

In a variation on this embodiment, the apparatus can operate based on a specialized software stack that includes a global flash translation layer (FTL). The FTL can manage storage operations on a respective memory channel of the apparatus.

In a further variation, the specialized software stack also includes a media management firmware that maintains health and integrity of the data.

### BRIEF DESCRIPTION OF THE FIGURES

FIG. 1A illustrates an exemplary infrastructure deploying efficient storage nodes with reduced protocol overhead, in accordance with an embodiment of the present application.

FIG. 1B illustrates an exemplary architecture of an efficient storage node with reduced protocol overhead, in accordance with an embodiment of the present application.

FIG. 2 illustrates an exemplary transition from a traditional storage node to an efficient storage node based on the reduction of an interfacing protocol, in accordance with an embodiment of the present application.

FIG. 3 illustrates an exemplary software and firmware stack for an efficient storage node, in accordance with an embodiment of the present application.

FIG. 4A illustrates an exemplary datacenter rack comprising efficient storage nodes, in accordance with an embodiment of the present application.

FIG. 4B illustrates an exemplary side view of the datacenter rack, in accordance with an embodiment of the present application.

FIG. 5A presents a flowchart illustrating a method of a lightweight storage node executing a storage operation, in accordance with an embodiment of the present application.

FIG. 5B presents a flowchart illustrating a method of a lightweight storage node using a secondary memory device as a buffer for executing a storage operation, in accordance with an embodiment of the present application.

FIG. 6 illustrates an exemplary computer system that facilitates an efficient storage node, in accordance with an embodiment of the present application.

FIG. 7 illustrates an exemplary apparatus that facilitates an efficient storage node, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein solve the problem of large fault zones, as well as increased cost and complexity, in a large-scale storage node by facilitating a lightweight storage node based on reduced protocol overhead.

With existing technologies, the disaggregation of compute and storage nodes has led to extensive expansion of storage capacities and deployment of large-scale high-capacity storage nodes. In particular, since the compute nodes typically process the user requests, modifications to the storage nodes can be less impactful. However, if such a high-capacity storage node yields a large amount of data with a high throughput, the network coupling the compute nodes and the storage nodes can face bottlenecks. Furthermore, a high-capacity storage node can expand the corresponding fault zone. For example, if such a storage node suffers from a fault, the entire node becomes unavailable. The high capacity of the node can lead to time-consuming data recovery. In addition, the high-capacity storage node may need complex software/hardware. This can hinder the flexibility of a storage node.

To solve these problems, embodiments described herein provide a lightweight storage node with a simplified design that reduces intermediate protocol transitions. The storage node can have an integrated network interface (e.g., an Ethernet interface), which can be coupled to a network switch for high-throughput data transfer. The storage node can include a number of processor cores that can address the operation and compute requirements of the storage nodes. In addition to the inherent compute tasks of the storage node, the processors can process the NAND flash storage operations. Typically, such operations are performed by a solid-state drive (SSD) controller that interfaces with the non-volatile memory devices (e.g., NAND flash devices). The lightweight storage node can use a core of the central processor to perform the operations of the SSD controller. In the same way, the flash translation layer (FTL) and NAND channel management can also be managed by the cores of the central processor.

To further enhance the efficiency, the storage node can be equipped with a set of hardware accelerators (e.g., a number of interconnected hardware modules) that can perform operations, such as compression, hash, deduplication, encryption, compaction, etc. In addition to the system memory (e.g., a dynamic random-access memory (DRAM) device), the storage can also include a static random-access memory (SRAM) buffer that can serve as a fast cache and facilitate data buffering for a limited quantity of data. The storage node can also include a Not OR (NOR) read-only memory (ROM) device for storing read-only configurations for the storage node. The storage node can include multiple sets of NAND flash devices, each set coupled with an error-correcting code (ECC) codec and a NAND interface. This allows parallel access to each of the multiple sets, thereby facilitating multi-channel access to the NAND flash storage.

In some embodiments, the storage node can include an internal bus that replaces internal fabrics, such as peripheral component interconnect express (PCIe). This reduces the intermediate protocol overhead associated with the PCIe protocol and provides a shortened latency. The storage node can use central memory and processor cores for networking, storage, and compute operations. As a result, the storage node eliminates the need for the encoding and decoding operations associated with the PCIe protocol (e.g., non-volatile memory express (NVMe)). This architecture further improves the efficiency of the storage node by freeing up processor cores from performing the operations associated with the submission queue (SQ) and completion queue (CQ), and the corresponding coding of the NVMe protocol. Instead, the processor cores can be directly used for NAND flash interfacing. This structure also simplifies the data movement within the storage node and reduces the memory copy operations, leading to an improved performance.

### Exemplary System

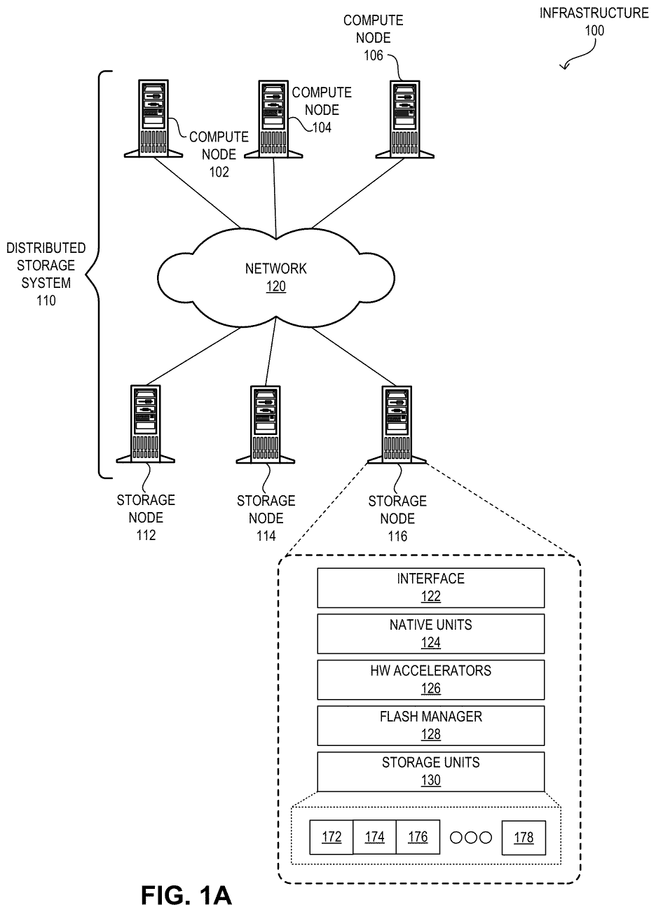

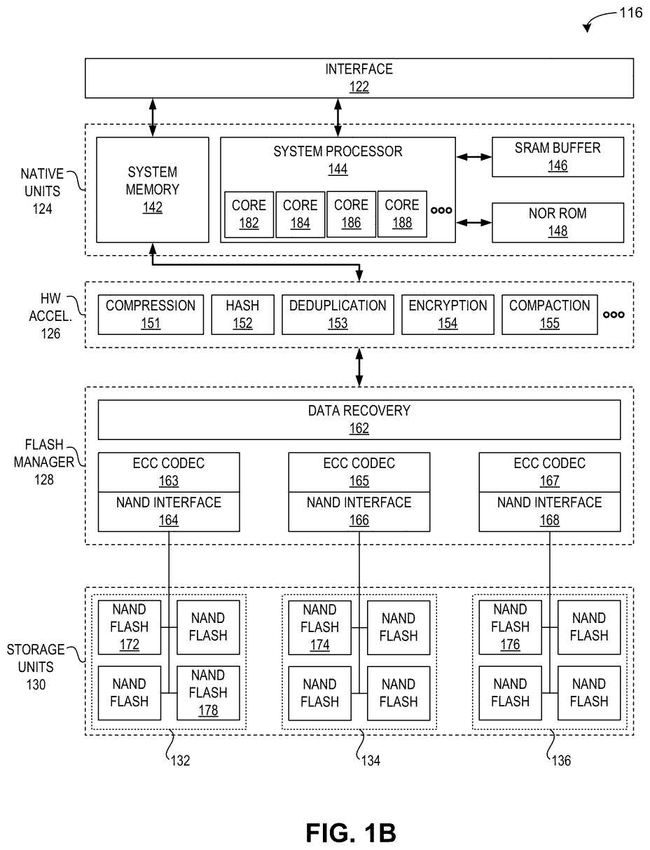

FIG. 1A illustrates an exemplary infrastructure deploying efficient storage nodes with reduced protocol overhead, in accordance with an embodiment of the present application. In this example, an infrastructure 100 can include a distributed storage system 110. System 110 can include: compute nodes (or client-serving machines) 102, 104, and 106, and storage nodes 112, 114, and 116. Compute nodes 102, 104, and 106, and storage nodes 112, 114, and 116 can communicate with each other via a network 120. Network 120 can be a local or a wide area network. For example, network 120 can be a high-throughput fabric (e.g., based on Fibre Channel (FC)). A respective storage node can include a number of components, such as a central processing unit (CPU), a memory device (e.g., a dual in-line memory module), a network interface card (NIC), and a number of storage units, such as NAND flash devices.

With existing technologies, disaggregation of compute and storage nodes in storage system 110 may support extensive expansion of storage capacities and deployment of large-scale high-capacity storage nodes. In particular, since compute nodes 102, 104, and 106 typically process the user requests, any potential modifications to the storage nodes in storage system 110 can be less impactful. However, if a high-capacity storage node yields a large amount of data with a high throughput, network 120 can face bottlenecks in its links and/or nodes. Furthermore, a high-capacity storage node can expand the corresponding fault zone. For example, if a storage node suffers from a fault, the entire node becomes unavailable. The high capacity of the node can lead to time-consuming data recovery. In addition, the high-capacity storage node may need complex software/hardware. This can hinder the flexibility of a storage node.

To solve these problems, storage nodes 112, 114, and 116 can be lightweight storage nodes with a simplified design that reduces intermediate protocol transitions. A respective storage node, such as storage node 116, can have a network interface (e.g., an Ethernet or an FC interface) 122, which can be coupled to network 120 for high-throughput data transfer. Storage node 116 can include a number of native units 124, which can include a number of processor cores and a system memory device (e.g., a DRAM device). The processor cores can address the operation and compute requirements of storage node 116. In addition to the inherent compute tasks of storage node 116, the processor cores can process the storage operations for a set of storage units 130, which can include NAND flash devices 172, 174, 176, and 178.

Typically, the storage operations are performed by an SSD controller that interfaces with NAND flash devices 172, 174, 176, and 178. However, storage node 116 can use a processor core to perform the operations of the SSD controller. In the same way, FTL, write retry, and NAND channel management can also be managed by the processor cores. To further enhance the efficiency, storage node 116 can be equipped with a set of hardware accelerators 126. Hardware accelerators 126 can include a number of interconnected hardware modules that can perform a number of operations executed for programming data on or retrieving data from storage units 130. The operations can include compression, hash, deduplication, encryption, compaction, etc.

Furthermore, storage node 116 can include a flash manager 128, which allows the processor cores to perform the read/write operations on storage units 130. Flash manager 128 can include a data recovery unit that can perform preprocessing operations for programming a NAND flash device. The processing operations can include, but are not limited to, error-correction processing and data storage virtualization (e.g., Redundant Array of Independent Disks (RAID)). Flash manager 128 can also facilitate ECC encoding and decoding, and interfacing with a respective NAND flash device in storage units 130. For example, flash manager 128 can facilitate ECC encoding and NAND cell programming for NAND flash devices 172, 174, 176, and 178.

FIG. 1B illustrates an exemplary architecture of an efficient storage node with reduced protocol overhead, in accordance with an embodiment of the present application. Native units 124 of storage node 116 can include a system memory device 142 (e.g., a DRAM device) and a multi-core system processor 144. Processor 144 can include a number of cores, which can include processor cores 182, 184, 186, and 188. Interface 122 can be integrated in storage node 116 in such a way that data received via interface 122 can be stored in memory device 142 and/or allocated to one of the cores, such as core 182, of processor 144 (e.g., to the cache of core 182). Core 182 can then perform the operations of an SSD controller, such as FTL, write retry, and channel management, on the data obtained via interface 122.

In addition to memory device 142, storage node 116 can also include an SRAM buffer 146 that can serve as a fast cache and facilitate data buffering for a limited quantity of data. Storage node 116 can also include a NOR ROM device 148 for storing read-only configurations for storage node 116. Upon completing the FTL and channel allocation operations, hardware accelerators 126 can perform a number of operations that allow efficient data storage. For example, compression unit 151 can compress the translated data, hash unit 152 can compute the hash of the data to ensure data consistency and encryption unit 154 can encrypt the data to ensure data safety. Compression unit 151 compresses the data blocks to reduce the amount of physical storage that is required on storage units 130. Deduplication unit 153 can eliminate duplicate data blocks and compaction unit 155 stores more data in less space to increase storage efficiency in storage units 130.

Flash manager 128 can include a data recovery unit 162 that can perform preprocessing operations for programming a NAND flash device. Flash manager 128 can also facilitate ECC encoding and decoding, and interfacing with a respective NAND flash device in storage units 130. Storage node 116 can include multiple sets 132, 134, and 136 of NAND flash devices. For example, set 132 can include NAND flash devices 172 and 178. Sets 132, 134, and 136 can be coupled with ECC codecs 163, 165, and 167, respectively, and NAND interfaces 164, 166, and 168, respectively. This allows parallel access to each of sets 132, 134, and 136. In this way, storage node 116 can facilitate multi-channel access to each set of NAND flash devices in storage units 130.

### Reduction of Protocol Overhead

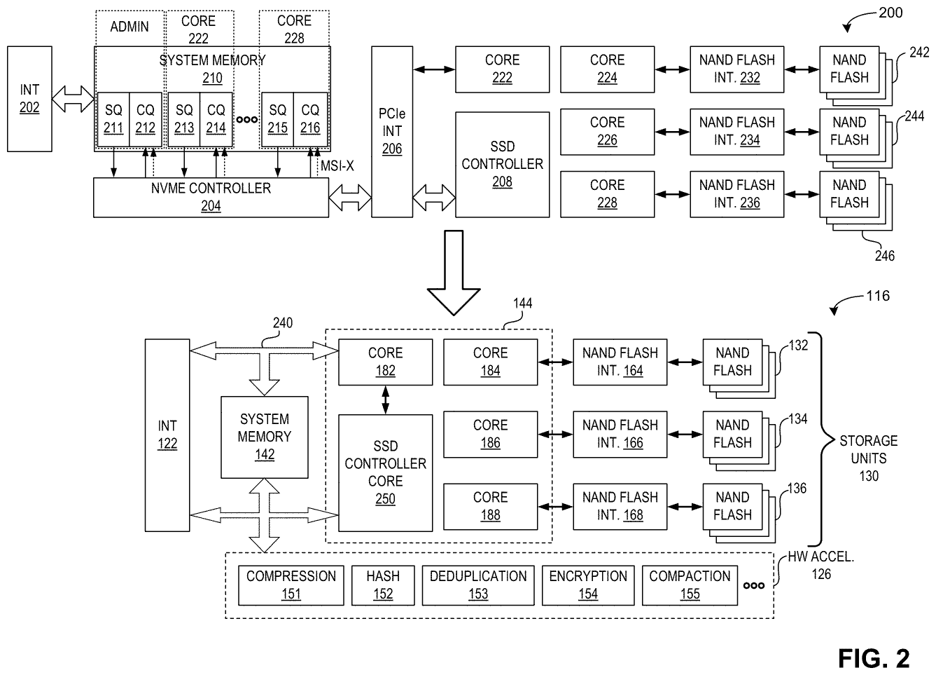

FIG. 2 illustrates an exemplary transition from a traditional storage node to an efficient storage node based on the reduction of an interfacing protocol, in accordance with an embodiment of the present application. A traditional storage node 200 can include an interface 202, which can be a pluggable network interface card (NIC) (e.g., a PCI card). As a result, data from interface 202 uses PCI for data exchange. Storage node 200 can be equipped with a number of processor cores 222, 224, 226, and 228. In addition, storage node 200 can include an SSD controller 208. The processor cores and SSD controller 208 can be interfaced with a PCIe interface 206. System memory device 210 can include an SQ and a CQ for administrative operations and a respective processor core. For example, system memory device 210 can include SQ 211 and CQ 212 for administrative operations, SQ 213 and CQ 214 for core 222, and SQ 215 and CQ 216 for core 228.

To facilitate communication via PCIe interface 206, NVMe controller 204 provides access to system memory device 210 to the processor cores using the NVMe protocol. To access data from system memory device 210 for core 222, NVMe controller 204 can issue an interrupt (e.g., a message signaled interrupt (MSI), such as MSI-X interrupt). This interrupt allows core 222 to access SQ 213 and CQ 214. Based on the data in SQ 213, core 222 can access a NAND flash device via a corresponding NAND flash interface. In storage node 200, NAND flash device sets 242, 244, and 246 can be accessed via NAND flash interfaces 232, 234, and 236, respectively. This process occupies the processing cycle of core 222 for accessing a NAND flash device. As a result, the data access to and from a NAND flash device in storage node 200 can have increased latency and inefficiency.

Storage node 116 can improve the efficiency by reducing the protocol overhead associated with an intermediate interface, such as the PCIe interface. Storage node 116 can include an internal bus 240 that can replace the traditional PCIe. This can provide a shortened latency for accessing data from sets 132, 134, and 136. Storage node 116 can use memory device 142 and processor cores of processor 144 for networking, storage, and compute operations. In this way, storage node 116 can eliminate the need for the encoding and decoding operations associated with the PCIe protocol (e.g., NVMe protocol). The architecture of storage node 116 further improves the efficiency of the storage operations by freeing up processor cores from performing the operations associated with the SQ and CQ, and the corresponding coding of the NVMe protocol.

Instead, processor cores 182, 184, 186, and 188 can be directly used for NAND flash interfacing. For example, core 182 can directly access set 132 of NAND flash devices using NAND flash interface 164. This structure simplifies the data movement within storage node 116 and reduces the memory copy operations, leading to an improved performance. In addition, processor core 250 can be used for executing the control operations associated with storage operations. In other words, processor core 250 can operate as an SSD controller core. As a result, the need for a separate microcontroller for managing the NAND flash devices can be eliminated. Instead, storage node 116 can use a processor core for the control operations.

### Software Stack

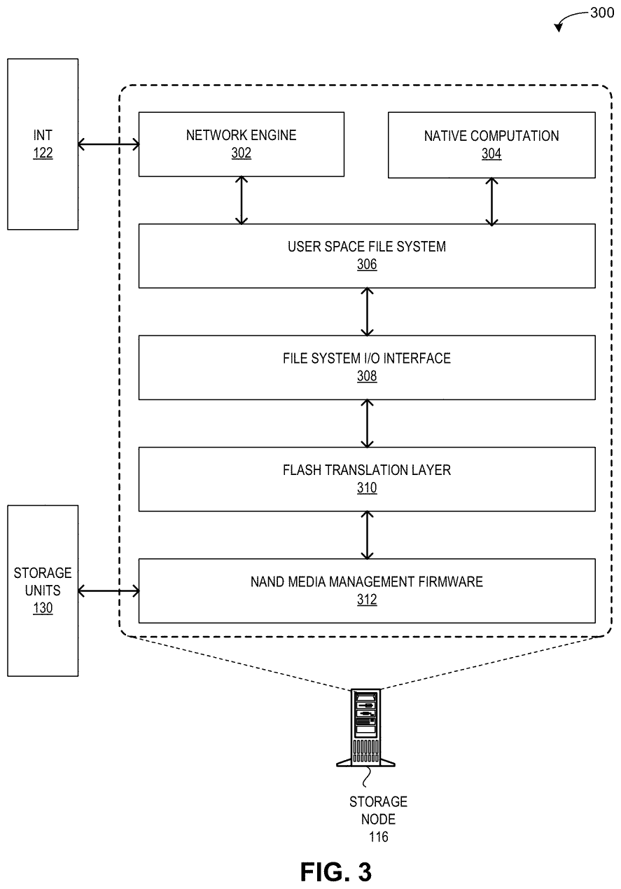

Since the lightweight architecture of storage node 116 reduces internal protocol overhead, the corresponding software stack should be restructured to correspond to the architecture. FIG. 3 illustrates an exemplary software and firmware stack for an efficient storage node, in accordance with an embodiment of the present application. Software stack 300 of storage node 116 facilitates the lightweight and efficient storage operations. Software stack 300 can include a network engine 302 comprising the networking driver associated with interface 122. Network engine 302 processes packets received and sent via interface 122, and facilitates remote direct memory access (RDMA) to and from storage node 116.

Stack 300 also includes a native computation layer 304 for supporting the local compute. Local compute includes the operations of storage node 116, such as data scrubbing, sanity checking, etc. User space file system 306 is a layer in stack 300 that is configured to provide a user space in storage node 116. User space file system 306 provides file, keys, object or block interface to the applications running on the user space. In other words, user space file system 306 facilitates the execution of user application on the user space of storage node 116. Stack 300 can further include a file system input/output (I/O) interface 308 that allows transfer of data from the user space to storage units 130 via a FTL 310.

In some embodiments, instead of executing multiple individual FTLs in parallel, FTL 310 manages all NAND flash channels in storage node 116 for storage operations (e.g., data placement, recycling, etc.) on storage units 130. This global scope within storage node 116 grants FTL 310 more flexibility regarding any performance trade-offs. For example, FTL 310 can balance the operations associated with the NAND flash front-end (e.g., storage commands from the user space) and back-end I/O (e.g., a command queue for executing the command). This allows FTL 310 to maintain a level of quality of service (QoS), which can be programmed for storage node 116, with a corresponding operational latency and an I/O isolation within storage node 116. Furthermore, using one or more processor cores of storage node 116, media management firmware 312 of stack 300 can handle the health and data integrity. It should be noted that media management firmware 312 can be implemented as a specialized firmware implementation that can efficiently execute on storage node 116.

### Datacenter Rack

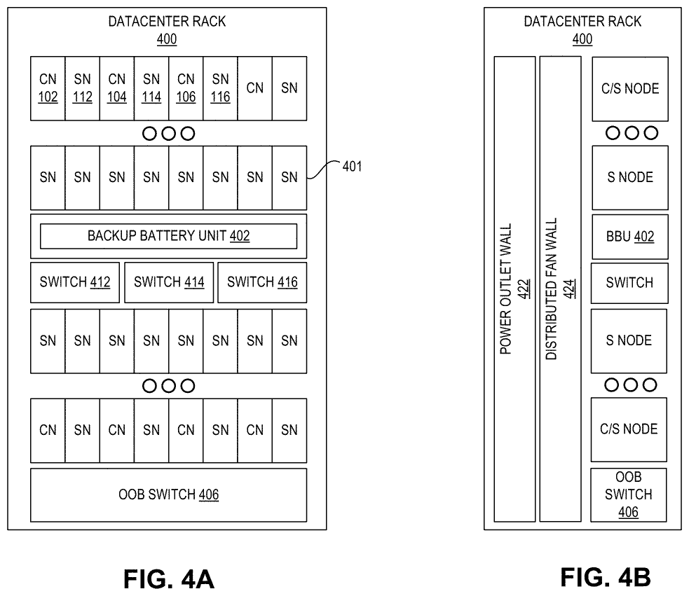

A lightweight storage node can have a smaller capacity and a smaller volume compared to a conventional storage node with a large number of drives. As a result, a datacenter rack may accommodate a higher number of lightweight storage nodes compared to the traditional ones using the same physical space. FIG. 4A illustrates an exemplary datacenter rack comprising efficient storage nodes, in accordance with an embodiment of the present application. In this example, in a datacenter rack 400, compute nodes 102, 104, and 106 can occupy the space needed for a traditional compute node. However, with lightweight storage nodes, rack 400 can accommodate a large number of storage nodes, such as storage nodes 112, 114, and 116. Rack 400 can also incorporate row 401 of only lightweight storage nodes. This increased number of storage nodes can provide the same high storage capacity in rack 400 with a distributed design and additional flexibility. In particular, if a lightweight storage node becomes unavailable, due to the reduced fault zone of the storage node, the impact on data management and recovery can be significantly reduced.

With an increased number of storage nodes in rack 400 and each storage node needing a network connection (e.g., an Ethernet connection), the number of ports per switch in rack 400 can be increased. For example, rack 400 can include a number of switches 412, 414, and 416, each with a large number of ports. Rack 400 can also include a back-up battery unit (BBU) 402, which can be shared by a respective node in rack 400. Since the data stored in rack 400 is distributed across a large number of storage nodes, to save power in emergency circumstances, rack 400 can turn off individual storage nodes to save power consumption from BBU 402. Rack 400 can also include an out-of-band (OOB) switch 406, which is used for out-of-band communication (i.e., not used for data exchange related to the storage operations). OOB switch 406 facilitates exchange of control data associated with the management rack 400 and the nodes in it.

FIG. 4B illustrates an exemplary side view of the datacenter rack, in accordance with an embodiment of the present application. To supply sufficient power to the nodes of rack 400, the power budget of rack 400 can be enlarged. Rack 400 can include a power outlet wall 422, which can include a large number (e.g., in the scale of hundreds) of power slots in which the connectors of the storage nodes and compute nodes of rack 400 can be plugged. Furthermore, to efficiently manage the space in rack 400, instead of having fans installed in each node, a distributed fan wall 424 can be installed in rack 400. Distributed fan wall 424 can be configured to operate in such a way that is can cool the entire rack. For example, distributed fan wall 424 can exhaust the heated air generated by all nodes in rack 400. In this way, the lightweight storage nodes can be efficiently installed and operated from rack 400.

### Operations

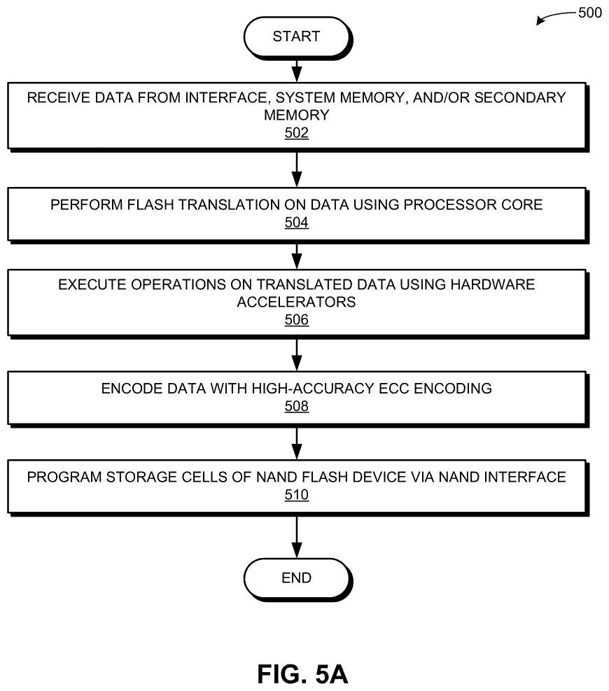

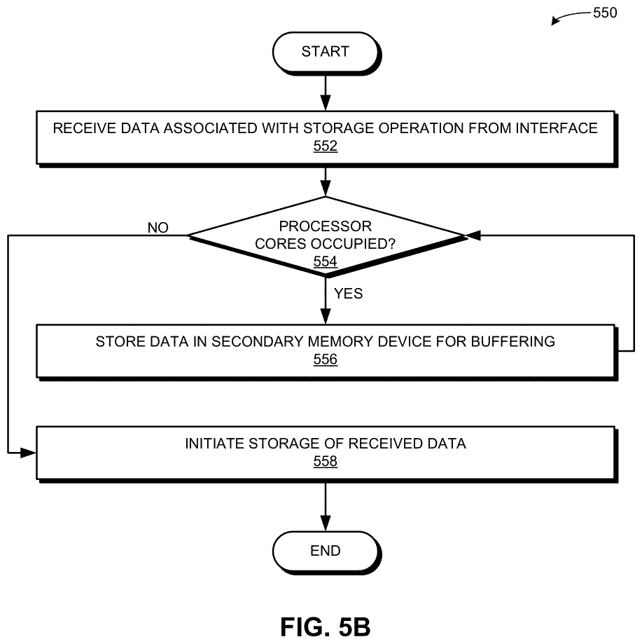

FIG. 5A presents a flowchart 500 illustrating a method of a lightweight storage node executing a storage operation, in accordance with an embodiment of the present application. During operation, the storage node can receive data from an interface (e.g., the Ethernet interface), the system memory, and/or a secondary memory (operation 502). For example, a compute node can provide data to the storage node based on RDMA, which accesses the system memory via the interface. The storage node can also receive data as a packet via the interface. The secondary memory can temporarily buffer the data. The storage node then performs a flash translation on the data using a processor core (operation 504), and executes operations on the translated data using a set of hardware accelerators (operation 506). The storage node encodes data with a high-accuracy ECC encoding (operation 508) and programs storage cells of a NAND flash device via the NAND interface (operation 510).

FIG. 5B presents a flowchart 550 illustrating a method of a lightweight storage node using a secondary memory device as a buffer for executing a storage operation, in accordance with an embodiment of the present application. During operation, the storage node receives data associated with the storage operation from the interface (operation 552) and determines whether the processor cores are occupied (operation 554). If the cores are occupied, the storage node stores the data in the secondary memory device (e.g., an SRAM distinct from the system memory) for buffering (operation 556) and continues to determine whether the processor cores are occupied (operation 554). If one or more processor cores are available (i.e., not occupied), the storage node initiates the storage of the received data (operation 556).

### Exemplary Computer System and Apparatus

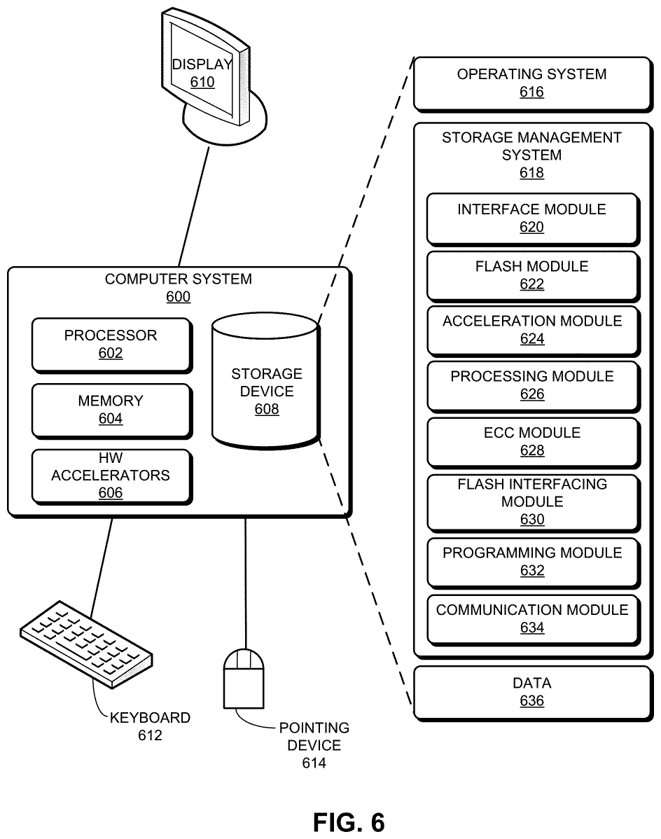

FIG. 6 illustrates an exemplary computer system that facilitates an efficient storage node, in accordance with an embodiment of the present application. Computer system 600 includes a processor 602, a memory 604, hardware accelerators 606, and a storage device 608. Memory 604 can include one or more of: a volatile memory (e.g., a dual in-line memory module (DIMM)) and a secondary memory (e.g., an SRAM). Furthermore, computer system 600 can be coupled to a display device 610, a keyboard 612, and a pointing device 614. Storage device 608 can include one or more NAND flash devices. Storage device 608 can store an operating system 616, a storage management system 618, and data 636. Computer system 600 can be a storage node, such as storage node 116, and storage management system 618 can facilitate the operations of the storage node.

Storage management system 618 can include instructions, which when executed by computer system 600 can cause computer system 600 to perform methods and/or processes described in this disclosure. Specifically, storage management system 618 can include instructions for obtaining data from and sending data to a compute node (interface module 620). Storage management system 618 can also include instructions for performing storage operations on the data for storing in or retrieving from a NAND flash device (e.g., FTL, write retry, channel allocation, etc.) (flash module 622). Furthermore, storage management system 618 includes instructions for facilitating hardware accelerators 606 to perform one or more specialized operations (acceleration module 624). The specialized operations can include, but are not limited to, compression, hash computation, deduplication, encryption, and compaction.

Moreover, storage management system 618 includes instructions for processing storage operations using the cores of processor 602 (processing module 626). Storage management system 618 further includes instructions for performing ECC operations (ECC module 628). In addition, storage management system 618 includes instructions for interfacing with the NAND flash devices (flash interfacing module 630) and programming one or more storage cells of the NAND flash devices (programming module 632). Storage management system 618 may further include instructions for sending and receiving messages (communication module 634). Data 636 can include any data that a compute node stores in the NAND flash devices in storage device 608.

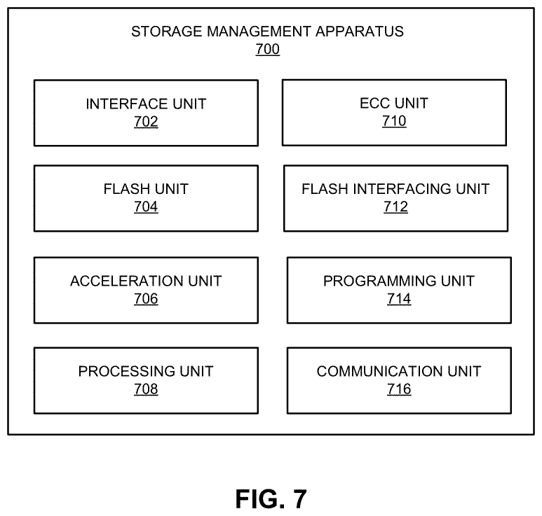

FIG. 7 illustrates an exemplary apparatus that facilitates an efficient storage node, in accordance with an embodiment of the present application. Storage management apparatus 700 can comprise a plurality of units or apparatuses that may communicate with one another via a wired, wireless, quantum light, or electrical communication channel. Apparatus 700 may be realized using one or more integrated circuits, and may include fewer or more units or apparatuses than those shown in FIG. 7. Further, apparatus 700 may be integrated in a computer system, or realized as a separate device that is capable of communicating with other computer systems and/or devices. Specifically, apparatus 700 can comprise units 702-716, which perform functions or operations similar to modules 620-634 of computer system 600 of FIG. 6, including: an interface unit 702; a flash unit 704; an acceleration unit 706; a processing unit 708; an ECC unit 710; a flash interfacing unit 712; a programming unit 714; and a communication unit 716.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. An apparatus facilitating a storage node, comprising:
a plurality of non-volatile memory devices;
an interface configured to receive data for storing in a non-volatile memory device of the plurality of non-volatile memory devices;
a processing module comprising a plurality of cores;
wherein a core of the processing module is configured to:
translate the data for storing in the non-volatile memory device; and
send the data to the non-volatile memory device;
an acceleration module configured to perform a set of specialized operations on the data; and
a storage module configured to store the data in the non-volatile memory device.

2. The apparatus of claim 1, wherein the acceleration module includes one or more of:
a compression module configured to compress the data;
a hash module configured to compute a hash of the data;
a deduplication module configured to remove redundancy from the data;
an encryption module configured to encrypt the data; and
a compaction module configured to represent the data in a compact representation for storing in the non-volatile memory device.

3. The apparatus of claim 1, further comprising a system memory device configured to store the data; and
wherein the core is further configured to obtain the data from the system memory.

4. The apparatus of claim 1, wherein the plurality of non-volatile memory devices includes multiple sets of non-volatile memory devices, wherein a respective set of non-volatile memory devices is associated with an error-correction module and a memory-interfacing module.

5. The apparatus of claim 4, wherein the non-volatile memory device is in the set of non-volatile memory devices;
wherein the error-correction module is configured to apply an error-correction coding (ECC) to the data; and
wherein the memory-interfacing module is configured to program the data in the non-volatile memory device.

6. The apparatus of claim 1, wherein the storage module further comprises a data recovery module configured to perform error-correction preprocessing and data storage virtualization.

7. The apparatus of claim 1, further comprising
a static memory device configured to operate as a buffer for the processing module; and
a read-only memory configured to store configuration information for the apparatus.

8. The apparatus of claim 1, wherein the apparatus is configured to cool based on an external fan.

9. The apparatus of claim 1, wherein the apparatus is configured to operate based on a specialized software stack comprising a global flash translation layer (FTL) configured to manage storage operations on a respective memory channel of the apparatus.

10. The apparatus of claim 9, wherein the specialized software stack further comprises a media management firmware configured to maintain health and integrity of the data.

11. A computer system for facilitating a distributed storage system, the computer system comprising:
a plurality of non-volatile memory devices;
a network interface card configured to receive data for storing in a non-volatile memory device of the plurality of non-volatile memory devices;
a processor comprising a plurality of cores;
wherein a core of the processor is configured to:
translate the data for storing in the non-volatile memory device; and
send the data to the non-volatile memory device;
a hardware accelerator configured to perform a set of specialized operations on the data; and
a storage interface configured to store the data in the non-volatile memory device.

12. The computer system of claim 11, wherein the hardware accelerator includes one or more of:
a compression module configured to compress the data;
a hash module configured to compute a hash of the data;
a deduplication module configured to remove redundancy from the data;
an encryption module configured to encrypt the data; and
a compaction module configured to represent the data in a compact representation for storing in the non-volatile memory device.

13. The computer system of claim 11, further comprising a system memory device configured to store the data; and
wherein the core is further configured to obtain the data from the system memory.

14. The computer system of claim 11, wherein the plurality of non-volatile memory devices includes multiple sets of non-volatile memory devices, wherein a respective set of non-volatile memory devices is associated with an error-correction module and a memory-interfacing module.

15. The computer system of claim 14, wherein the non-volatile memory device is in the set of non-volatile memory devices;
wherein the error-correction module is configured to apply an error-correction coding (ECC) to the data; and
wherein the memory-interfacing module is configured to program the data in the non-volatile memory device.

16. The computer system of claim 11, wherein the storage interface further comprises a data recovery module configured to perform error-correction preprocessing and data storage virtualization.

17. The computer system of claim 11, further comprising
a static memory device configured to operate as a buffer for the processing module; and
a read-only memory configured to store configuration information for the computer system.

18. The computer system of claim 11, wherein the computer system is configured to cool based on an external fan.

19. The computer system of claim 11, wherein the computer system is configured to operate based on a specialized software stack comprising a global flash translation layer (FTL) configured to manage storage operations on a respective memory channel of the computer system.

20. The computer system of claim 19, wherein the specialized software stack further comprises a media management firmware configured to maintain health and integrity of the data.
